(19) United States
(12) Patent Application Publication
(10) Pub. No.: US 2017/0087874 A1
(43) Pub. Date: Mar. 30, 2017

(54) DRYING DEVICE, INKJET RECORDING DEVICE, AND DRYING METHOD

(71) Applicant: FUJIFILM CORPORATION, Tokyo (JP)

(72) Inventor: Noriaki MAIDA, Kanagawa (JP)

(21) Appl. No.: 15/247,931

(22) Filed: Aug. 26, 2016

(30) Foreign Application Priority Data
Sep. 30, 2015 (JP) 2015-195104

(51) Int. Cl. B41J 11/00; B41J 2/01

(52) U.S. Cl. CPC B41J 11/002; B41J 2/01

(57) ABSTRACT

There is provided a drying device including (i) a drying portion having a plurality of drying units, the drying unit configured to dry liquid droplets that have been jetted onto a recording medium with a drying intensity that varies along an intersecting direction intersecting a conveyance direction of the recording medium, with the plurality of drying units being provided along the conveyance direction, and (ii) a control portion that controls the drying intensity of the respective drying units according to an application amount of the liquid droplets in each of a plurality of divided regions, the divided regions defined by dividing the recording medium into regions along the respective directions of the conveyance direction and the intersecting direction.

### CROSS-REFERENCE TO RELATED APPLICATION

This application claims priority under 35 USC 119 from Japanese Patent application No.2015-195104 filed on Sep. 30, 2015, the disclosure of which is incorporated by reference herein.

### BACKGROUND

Technical Field

The present disclosure relates to a drying device, an inkjet recording device, and a drying method.

Related Art

Technology is known for drying liquid droplets that have been jetted onto a recording medium. As such technology, Japanese Patent Application Laid-Open (JP-A) No. 2011-230465 describes a liquid ejecting apparatus including liquid ejecting heads that record by ejecting liquid onto a recording medium being conveyed from upstream to downstream. This liquid ejecting apparatus includes a heating means that heats the recording medium at a position further toward the downstream than the liquid ejecting heads in a conveyance direction of the recording medium. In this liquid ejecting apparatus, the heating means is disposed running along a width direction of the recording medium that intersects the conveyance direction. Moreover, in this liquid ejecting apparatus, for each of plural divided regions defined by dividing the recording medium into regions along the width direction, a heat amount that the heating means applies to a first region of the recording medium, and a heat amount that the heating means applies to a second region of the recording medium adjacent to the first region in the width direction are different from each other.

Namely, in the technology described in JP-A No. 2011-230465, the liquid droplets that have been jetted onto the recording medium are dried with drying intensities that differ along the intersecting direction that intersects with the conveyance direction of the recording medium by varying the heat amount applied along the intersecting direction.

JP-A No. 2013-028118 describes a printer including a printing means that applies ink to a sheet while moving a print head back and forth with respect to the sheet. This printer includes a drying means that imparts energy to the sheet applied with ink by the printing means, so as to promote drying. Moreover, in this printer, greater energy is imparted from the drying means at end portions than at the center of a movement range of the print means across the sheet. Moreover, JP-A No. 2013-028118 describes adopting a heater as the drying means, configuring the heater with a single long, thin element, providing heat blocking shutters at respective divided regions, and varying opening and closing timings of the shutters.

However, as illustrated as an example in FIG. 12, in JP-A No. 2011-230465, although it is possible to divide paper P, serving as a recording medium, into plural regions along the intersecting direction and vary the drying intensity between each of the divided regions, it is not possible to vary the drying intensity along the conveyance direction of the paper P.

Accordingly, as illustrated in FIG. 12, in the technology described in JP-A No. 2011-230465, in cases in which, for example, an image with a pattern of horizontal stripes at intervals along the conveyance direction of the paper P is formed on the paper P, the paper P may deform in the conveyance direction as a result of applying a uniform heat amount (namely, drying at a uniform drying intensity) both at portions where liquid droplets have not been jetted onto the paper P, and portions where liquid droplets have been jetted onto the paper P.

On the other hand, in the technology described in JP-A No. 2013-028118, it is possible to vary the drying intensity in the conveyance direction of the recording medium by varying opening and closing durations of shutters. However, in the technology described in JP-A No. 2013-028118, in order to raise the drying precision of the liquid droplets, it is necessary to pause conveyance of the recording medium at each divided region along the conveyance direction of the recording medium, resulting a marked decrease in the conveyance velocity of the recording medium in this case.

### SUMMARY

The present disclosure provides a drying device, an inkjet recording device, and a drying method capable of drying liquid droplets effectively while suppressing a reduction in the conveyance velocity of a recording medium.

A first aspect of the present disclosure is drying device including a drying portion having plural drying units, the drying unit configured to dry liquid droplets that have been jetted onto a recording medium with a drying intensity that varies along an intersecting direction intersecting a conveyance direction of the recording medium. The plural drying units are provided along the conveyance direction. The drying device further includes a control portion that controls the drying intensity of the respective drying units according to an application amount of the liquid droplets in each of plural divided regions, the divided regions defined by dividing the recording medium into regions along the respective directions of the conveyance direction and the intersecting direction.

This thereby enables the liquid droplets to be dried effectively, while suppressing a reduction in conveyance velocity of the recording medium.

A second aspect of the present disclosure is the drying device of the first aspect, wherein the control portion controls such that a total value of drying intensity of the respective drying units matches a drying intensity determined according to the application amount of the liquid droplets in each of the divided regions.

This thereby enables simple acquisition of the application amounts of the liquid droplets in each of the divided regions of the recording medium that is divided into plural regions, and simple control of the drying intensity of the respective drying units.

A third aspect of the present disclosure is the drying device of either the first aspect or the second aspect, wherein the drying units include an infrared lamp as a drying source of the liquid droplets.

This thereby enables control of the drying intensity of each of the divided regions of the recording medium that is divided into plural regions to be realized with a simple configuration.

A fourth aspect of the present disclosure is the drying device of the third aspect, wherein the drying units further include a switching member that switches between blocking and not blocking light irradiation from the infrared lamp onto each of the divided regions.

This thereby enables more effective control of the drying intensity of each of the divided regions of the recording medium that is divided into plural regions, while suppressing a reduction in the conveyance velocity of the recording medium.

A fifth aspect of the present disclosure is the drying device of the fourth aspect, wherein the switching member is a shutter member configured to be opened and closed.

This thereby enables the switching member that switches between blocking and not blocking light irradiation from the infrared lamp onto each of the divided regions to be realized by a simple configuration.

A sixth aspect of the present disclosure is the drying device of the fifth aspect, wherein the control portion controls drying intensity of the drying units by controlling opening and closing of the shutter member.

This thereby enables control of switching between blocking and not blocking light irradiation from the infrared lamp onto each of the divided regions to be realized by a simple configuration.

A seventh aspect of the present disclosure is the drying device of either the fifth aspect or the sixth aspect, wherein the shutter member is a mechanical shutter member

This thereby enables stable drying of the liquid droplets without deformation of the shutter member, even if the drying units emit a high output heat amount.

An eighth aspect of the present disclosure is the drying device of any one of the first aspect to the seventh aspect, wherein the drying unit is configured to vary drying intensity in the intersecting direction so as to correspond to the respective divided regions along the intersecting direction.

A ninth aspect of the present disclosure is an inkjet recording device including a conveyance portion that conveys a recording medium, a jetting portion that jets ink droplets onto the recording medium being conveyed by the conveyance portion, and the drying device of any one of the first aspect to the eighth aspect that dries the liquid droplets, the liquid droplets being the ink droplets on the recording medium being conveyed by the conveyance portion.

A tenth aspect of the present disclosure is the inkjet recording device of the ninth aspect, wherein the jetting portion jets the ink droplets using a single pass method.

This thereby enables effective drying of the liquid droplets, while suppressing a reduction in the conveyance velocity of the recording medium so as not to lose the advantage of a single pass method having a faster printing speed than a shuttle scan method.

An eleventh aspect of the present disclosure is a drying method including conveying a recording medium onto which liquid droplets have been jetted, and drying the liquid droplets on the recording medium that is being conveyed by controlling a drying intensity of respective drying units of a drying portion having plural of the drying units provided along the conveyance direction the drying units configured to dry the liquid droplets that have been jetted onto the recording medium with a drying intensity that varies along an intersecting direction intersecting the conveyance direction of the recording medium, according to an application amount of the liquid droplets in each of plural divided regions, the divided regions defined by dividing the recording medium into regions along the respective directions of the conveyance direction and the intersecting direction.

The present disclosure thereby enables liquid droplets to be dried effectively, while suppressing a reduction in conveyance velocity of a recording medium.

### BRIEF DESCRIPTION OF THE DRAWINGS

An exemplary embodiment of the present disclosure will be described in detail based on the following figures, wherein:

FIG. 1 is a cutaway side view illustrating an example of relevant configuration of an inkjet recording device according to an exemplary embodiment;

FIG. 2 is a schematic configuration diagram of an example of relevant configuration of a drying unit according to an exemplary embodiment, in which (1) is a side view cross-section from the left, (2) is a bottom face view, and (3) is a side view cross-section from the right;

FIG. 3 is a bottom face view illustrating an example of relevant configuration of an ink droplet drying section according to an exemplary embodiment;

FIG. 4 is a functional block diagram illustrating an example of functional configuration of an inkjet recording device according to an exemplary embodiment;

FIG. 5 is a plan view to aid explanation of divided regions according to an exemplary embodiment;

FIG. 6 is a schematic diagram illustrating an example of opening/closing pattern information according to an exemplary embodiment;

FIG. 7 is a schematic diagram to aid explanation of a front loading method according to an exemplary embodiment;

FIG. 8 is a schematic diagram to aid explanation of a thinning method according to an exemplary embodiment;

FIG. 9 is a block diagram illustrating an example of relevant configuration of an electrical system of an inkjet recording device according to an exemplary embodiment;

FIG. 10 is a flowchart illustrating a processing flow of a drying processing program according to an exemplary embodiment;

FIG. 11 is a timing chart illustrating shutter opening and closing timings according to an exemplary embodiment; and

FIG. 12 is a plan view to aid explanation of related technology.

### DETAILED DESCRIPTION

Detailed explanation follows regarding an exemplary embodiment of the present disclosure, with reference to the drawings.

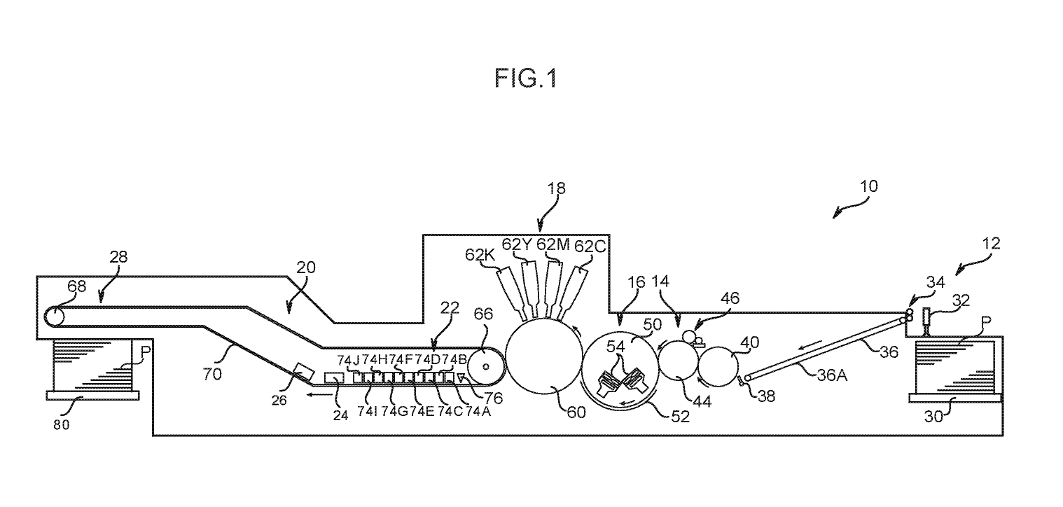

First, explanation follows regarding configuration of an inkjet recording device 10 according to the present exemplary embodiment, with reference to FIG. 1. Note that in the following explanation, yellow is represented by Y, magenta is represented by M, cyan is represented by C, and black is represented by K. When it is necessary to distinguish between respective configuration components or ink droplets by color, the reference numerals are suffixed with the letters Y, M, C, K corresponding to the respective colors. In the following explanation, when the respective configuration components and ink droplets are described generally, without distinguishing by color, the color suffixes are omitted from the reference numerals.

As illustrated in FIG. 1, the inkjet recording device 10 according to the present exemplary embodiment includes a paper feed section 12 that feeds paper P such as sheet paper, serving as an example of a recording medium, a process liquid application section 14 that applies process liquid to the paper P, and a process liquid drying section 16 that dries the process liquid applied to the paper P. The inkjet recording device 10 further includes an image forming section 18 that forms an image by jetting ink droplets, serving as an example of liquid droplets, onto the paper P, and a conveyance section 20 that conveys the paper P, on which an image has been formed by the image forming section 18, to a paper discharge section 28, described later.

The inkjet recording device 10 further includes an ink droplet drying section 22 that dries the ink droplets that have been jetted onto the paper P, and an ultraviolet irradiation section 24 that irradiates the paper P with ultraviolet rays. The inkjet recording device 10 further includes a cooling section 26 that cools the paper P, and the paper discharge section 28 from which the paper P is discharged.

The paper feed section 12 according to the present exemplary embodiment includes a paper feed tray 30, a sucker device 32, a paper feed roller pair 34, a feeder board 36, a front stopper 38, and a paper feed drum 40. The sucker device 32 lifts the paper P stacked on the paper feed tray 30 one sheet at a time in sequence from the top, and feeds the lifted paper P to the paper feed roller pair 34 one sheet at a time. The paper feed roller pair 34 rotate due to being supplied with drive force from a motor, not illustrated in the drawings, thereby conveying the paper P fed from the sucker device 32 onto the feeder board 36.

The feeder board 36 is formed corresponding to the width of the paper P, this being the length of the paper P in an intersecting direction intersecting a conveyance direction of the paper P. In the present exemplary embodiment, the width of the paper P is the length of the paper P in an orthogonal direction orthogonal to the conveyance direction of the paper P.

In the present specification, the term “orthogonal” encompasses substantially orthogonal cases in which the angle of intersection exceeds 90° or the angle of intersection is less than 90°, in which similar operation and advantageous effects are exhibited to when intersecting at 90°.

Note that in the following explanation, the conveyance direction of the paper P is also referred to as simply the “conveyance direction”. In the following explanation, the intersecting direction intersecting the conveyance direction is also referred to as simply the “intersecting direction”.

Plural belt conveyance mechanisms 36A with their length directions running along the conveyance direction are installed to the feeder board 36 at intervals in the intersecting direction. Each of the belt conveyance mechanisms 36A is formed in an endless belt shape, and rotates due to being supplied with drive force from a motor, not illustrated in the drawings. The paper P conveyed from the paper feed roller pair 34 along the feeder board 36 is conveyed to the front stopper 38 by the rotation of the belt conveyance mechanisms 36A.

The front stopper 38 shakes due to being supplied with drive force from a motor, not illustrated in the drawings, thereby correcting the conveyance orientation of the paper P that has been conveyed from the feeder board 36 and contacted the front stopper 38. The paper feed drum 40 rotates due to being supplied with drive force from a motor, not illustrated in the drawings, and conveys the paper P conveyed from the feeder board 36 past the front stopper 38 to the process liquid application section 14.

The process liquid application section 14 according to the present exemplary embodiment includes a process liquid application drum 44 and a process liquid application unit 46. The process liquid application drum 44 rotates due to being supplied with drive force from a motor, not illustrated in the drawings, and conveys the paper P conveyed from the paper feed drum 40 to the process liquid drying section 16.

The process liquid application unit 46 includes a process liquid application roller that applies the process liquid, and a process liquid tank in which the process liquid is stored. The process liquid application unit 46 is provided facing the surface of the process liquid application drum 44 on the conveyance path of the paper P. The process liquid application unit 46 applies the process liquid to one face (referred to below as the “image forming face”) of the paper P being conveyed by the process liquid application drum 44. Note that in the present exemplary embodiment, as an example, a highly acidic liquid containing an aggregation agent that has a function of aggregating colorant (pigment) contained in the ink droplets that are jetted onto the image forming face of the paper P by the image forming section 18, described later, is applied as the process liquid.

In the following explanation, the conveyance path of the paper P is also referred to as simply the “conveyance path”.

The process liquid drying section 16 according to the present exemplary embodiment includes a process liquid drying drum 50, a paper conveyance guide 52, and plural process liquid drying units 54 (two in the present exemplary embodiment). The process liquid drying drum 50 is configured by a frame body assembled in a circular cylinder shape, and rotates due to being supplied with drive force from a motor, not illustrated in the drawings, so as to convey the paper P conveyed from the process liquid application drum 44 to the image forming section 18.

The paper conveyance guide 52 is provided following the conveyance path of the paper P at the peripheral outside of the process liquid drying drum 50, such that the paper P does not come away from the process liquid drying drum 50. The process liquid drying units 54 blow drying air onto the image forming face of the paper P being conveyed by the process liquid drying drum 50 so as to dry the process liquid coated on the image forming face of the paper P. A flocculated ink layer, in which the solvent has been removed from the process liquid, is thereby formed on the image forming face of the paper P.

The image forming section 18 according to the present exemplary embodiment includes an image forming drum 60, and inkjet heads 62C, 62M, 62Y, 62K. The image forming drum 60 rotates due to being supplied with drive force by a motor, not illustrated in the drawings, and conveys the paper P conveyed from the process liquid drying drum 50 to the conveyance section 20.

The inkjet heads 62C, 62M, 62Y, 62K are disposed facing an outer peripheral face of the image forming drum 60, in the above sequence, at uniform intervals along the conveyance path of the paper P. Each of the inkjet heads 62 includes a line head with a width corresponding to the width of the paper P, and a nozzle face of the line head is disposed facing the outer peripheral face of the image forming drum 60.

In each of the inkjet heads 62, a row of nozzles formed at the nozzle face faces the outer peripheral face of the image forming drum 60, and jets ink droplets of the corresponding CMYK color so as to form an image on the paper P being conveyed by the image forming drum 60. Namely, the inkjet heads 62 according to the present exemplary embodiment are configured so as to form an image using a single pass method for forming one line of an image in a single pass. Note that in the present exemplary embodiment, as an example, explanation is given regarding a case in which a water-based ultraviolet ink cured by irradiation with ultraviolet rays is applied as the ink; however, there is no limitation thereto. For example, another ink that fixes to the paper P when dried may be applied as the ink.

The conveyance section 20 according to the present exemplary embodiment is a conveyance mechanism commonly employed in the ink droplet drying section 22, the ultraviolet irradiation section 24, and the cooling section 26, and conveys the paper P conveyed from the image forming drum 60 to the paper discharge section 28.

The conveyance section 20 includes first sprockets 66, second sprockets 68, and chains 70. The endless chains 70 are entrained around the first sprockets 66 and the second sprockets 68. The first sprockets 66, the second sprockets 68, and the chains 70 are respectively provided in pairs corresponding to both edges of the paper P in the intersecting direction.

Plural grippers, not illustrated in the drawings, are provided spanning between the pair of chains 70 at uniform intervals in the conveyance direction. The grippers grip a leading edge portion of the paper P conveyed from the image forming drum 60. The first sprockets 66 rotate due to being supplied with drive force from a motor, not illustrated in the drawings, and the second sprockets 68 and the chains 70 rotate accompanying this rotation. The paper P is conveyed by the conveyance section 20 with the above configuration.

The ink droplet drying section 22, serving as an example of a drying portion according to the present exemplary embodiment, includes plural drying units 74A to 74J (ten in the present exemplary embodiment). The drying units 74A to 74J according to the present exemplary embodiment are disposed in the above sequence at uniform intervals along the conveyance direction. The drying units 74A to 74J each face the image forming face of the paper P being conveyed by the conveyance section 20, and irradiate ultraviolet rays to dry the ink droplets that have been jetted onto the image forming face of the paper P. Note that the configuration of the drying units 74A to 74J will be described in detail later.

A paper detection sensor 76 is provided on the conveyance path at downstream of the image forming drum 60 and at upstream side the ink droplet drying section 22. The paper detection sensor 76 according to the present exemplary embodiment is, as an example, a reflective type optical sensor including a light emitting element and a light receiving element in a pair.

The paper detection sensor 76 illuminates light from the light emitting element at a detection position corresponding to the installation position of the paper detection sensor 76 on the conveyance path. The paper detection sensor 76 outputs signals (referred to below as “detection signals”) at a signal level that corresponds to the amount of light received by the light receiving element. While the paper P is passing the detection position described above, light illuminated by the light emitting element is reflected by the paper P. Accordingly, the paper detection sensor 76 outputs detection signals at different signal levels while the paper P is passing the detection position described above and while the paper P is not passing the detection position described above. In the present exemplary embodiment, a reflective type optical sensor is employed as the paper detection sensor 76; however, there is no limitation thereto, and another sensor such as a transmissive type optical sensor may be applied.

The ultraviolet irradiation section 24 according to the present exemplary embodiment is provided on the conveyance path at downstream of the drying units 74A to 74J and at upstream of the cooling section 26, described later. The ultraviolet irradiation section 24 irradiates the image forming face of the paper P being conveyed by the conveyance section 20 with ultraviolet rays.

The cooling section 26 according to the present exemplary embodiment is provided on the conveyance path at downstream of the ultraviolet irradiation section 24 and at upstream of the paper discharge section 28. The cooling section 26 cools the paper P being conveyed by the conveyance section 20 by blowing air toward the image forming face of the paper P.

The paper P that has passed through each of the sections described above is conveyed to a position corresponding to the paper discharge section 28 by the conveyance section 20, and is discharged onto a paper discharge tray 80 of the paper discharge section 28.

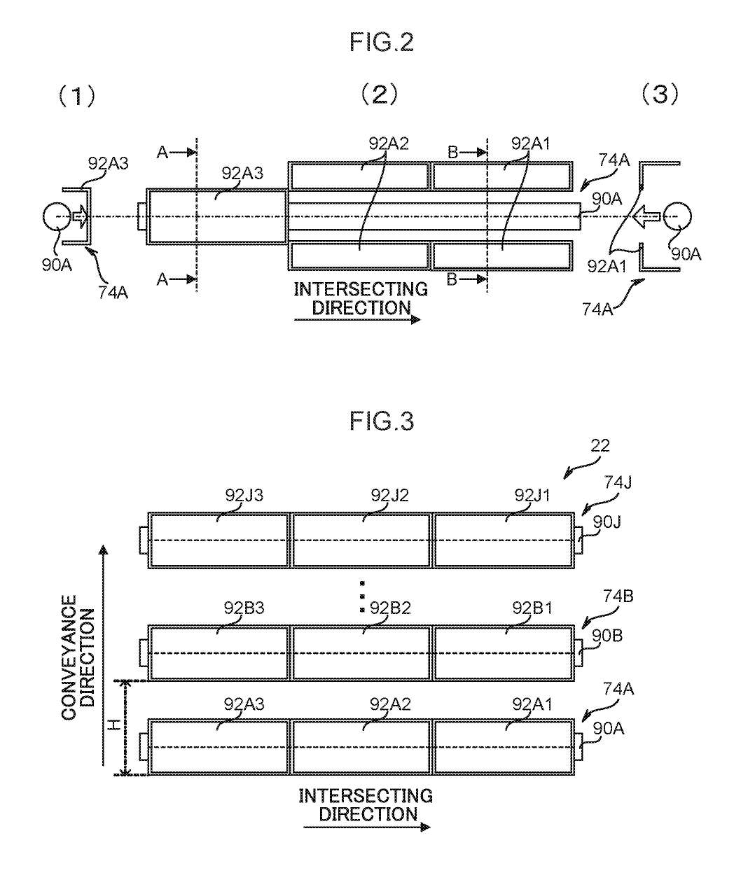

Next, explanation follows regarding configuration of the drying unit 74A according to the present exemplary embodiment, with reference to FIG. 2. Note that although FIG. 2 explains configuration of the drying unit 74A, the drying units 74B to 74J are of similar configuration. FIG. 2 (2) is a bottom face view of the drying unit 74A. FIG. 2 (1) is a cross-section taken along line A-A in FIG. 2 (2), and the right direction in FIG. 2 (1) corresponds to the direction heading toward the front in FIG. 2 (2). FIG. 2 (3) is a cross-section taken along line B-B in FIG. 2 (2), and the left direction in FIG. 2 (3) corresponds to the direction heading toward the front in FIG. 2 (2). The hollow arrows in FIG. 2 (1) and FIG. 2 (3) indicate the direction in which infrared rays are irradiated from an infrared lamp 90A, described later.

As illustrated in FIG. 2, the drying unit 74A according to the present exemplary embodiment includes the single infrared lamp 90A that irradiates infrared rays toward the paper P. The drying unit 74A includes plural shutters 92A1 to 92A3 (three in the present exemplary embodiment), disposed in a line along the intersecting direction. The shutters 92A1 to 92A3 are examples of switching members. In the following explanation, the final numbers are omitted from the reference numerals in general description that does not distinguish between the shutters 92A1 to 92A3.

The infrared lamp 90A according to the present exemplary embodiment is formed in an elongated shape, and has a length in its length direction that is the width of the paper P or greater.

The shutter 92A according to the present exemplary embodiment is formed by infrared blocking members, and is provided on the side of the conveyance path configured by the conveyance section 20 with respect to the infrared lamp 90A. The shutter 92A is principally configured by two members that are L-shaped as viewed in cross-section, and is capable of adopting a closed state (the state illustrated in FIG. 2 (1), for example) in which one end portion of each member contacts the other to form a C-shape as viewed in cross-section. The shutter 92A is also capable of adopting an open state (the state illustrated in FIG. 2 (3), for example) in which the above-described one end portions of the respective members are in a state separated from each other within a predetermined range. The shutter 92A blocks infrared rays in the closed state, and allows infrared rays to pass in the open state (becomes non-blocking). The shutter 92A is switched between the open state and the closed state by an opening and closing mechanism 130 (see FIG. 9), described later.

The shutter 92A is formed principally from aluminum. Accordingly, the shutter 92A does not deform, enabling more stable droplet drying, even when the drying unit 74A emits a high output heat amount.

Due to the above configuration, the drying unit 74A according to the present exemplary embodiment is capable of drying the ink droplets that have been jetted onto the paper P with a drying intensity that varies along the intersecting direction.

Next, explanation follows regarding configuration of the ink droplet drying section 22 according to the present exemplary embodiment, with reference to FIG. 3. As illustrated in FIG. 3, in the ink droplet drying section 22 according to the present exemplary embodiment, the drying units 74A to 74J are disposed at uniform intervals, in this sequence from the conveyance direction upstream side. Note that in the following explanation, the final letters are omitted from the reference numerals in general description that does not distinguish between the infrared lamps 90A to 90J. Moreover, in the following explanation, the final letters and numbers are omitted from the reference numerals in general description that does not distinguish between the shutters 92A1 to 92A3.

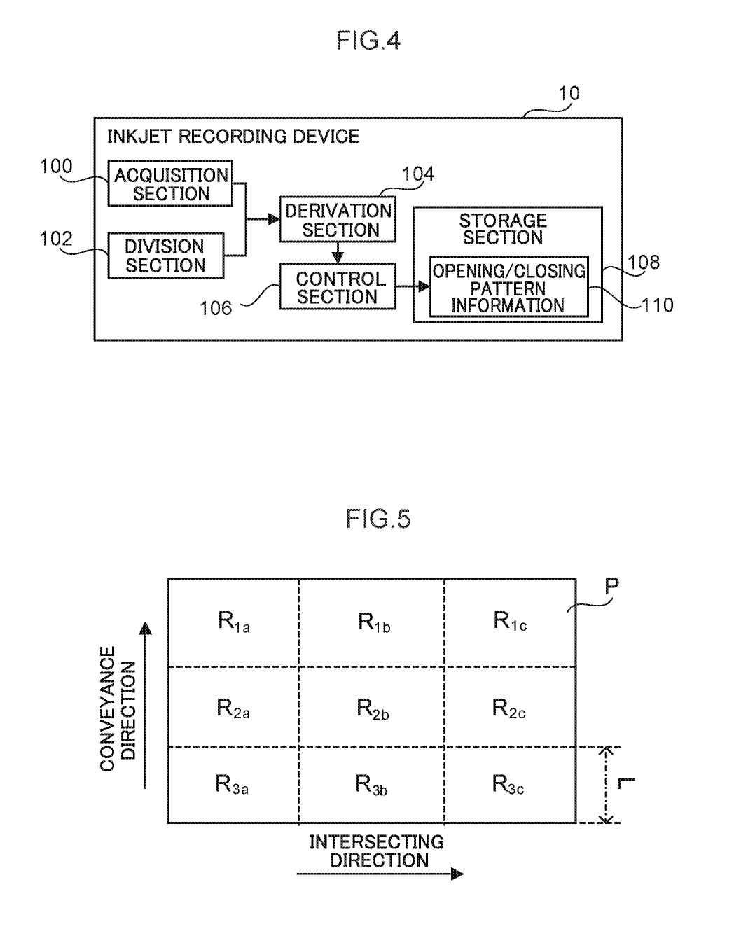

Next, explanation follows regarding functional configuration relating to the execution of processing to dry the ink droplets that have been jetted onto the paper P in the inkjet recording device 10, with reference to FIG. 4. As illustrated in FIG. 4, the inkjet recording device 10 according to the present exemplary embodiment includes an acquisition section 100, a division section 102, a derivation section 104, a control section 106, and a storage section 108.

The acquisition section 100 according to the present exemplary embodiment acquires image information expressing an image to be formed by the image forming section 18. The division section 102 according to the present exemplary embodiment divides the paper P into plural regions in the conveyance direction and the intersecting direction respectively. Specifically, as illustrated as an example in FIG. 5, in the intersecting direction, the division section 102 divides the paper P into a number of divided regions equal to the number (three in the present exemplary embodiment) of the shutters 92 of the respective drying units 74 about partitioning lines running along the conveyance direction. In the conveyance direction, the division section 102 divides the paper P into a predetermined number of divided regions (three in the present exemplary embodiment) about partitioning lines running along the intersecting direction.

Namely, as illustrated in FIG. 5, the division section 102 according to the present exemplary embodiment divides the paper P into 3×3=9 rectangular shaped divided regions R₁ₐ to R_{1c}, R₂ₐ to R_{2c}, R₃ₐ to R_{3c}. The width of the respective divided regions R₁ₐ to R_{1c}, R₂ₐ to R_{2c}, R₃ₐ to R_{3c} in the intersecting direction is a width corresponding to the shutters 92 disposed at the corresponding positions. It is sufficient that the predetermined number described above is set to an integer of two or greater, according to the demanded drying precision, for example. In the following explanation, the characters appended to the reference numerals are omitted in general description that does not distinguish between the respective divided regions R₁ₐ to R_{1c}, R₂ₐ to R_{2c}, R₃ₐ to R_{3c}.

The derivation section 104 according to the present exemplary embodiment derives a drying intensity for the respective divided regions R divided by the division section 102, based on the image information acquired by the acquisition section 100. Specifically, based on the image information, the derivation section 104 derives application amounts of the ink droplets that have been jetted onto the respective divided regions R of the paper P from the respective inkjet heads 62. The derivation section 104 then derives the drying intensity for the respective divided regions R based on the derived application amounts. Specifically, as an example, the derivation section 104 derives a higher drying intensity the larger the derived application amount. Note that in the present exemplary embodiment, in order to avoid confusion, explanation is given regarding a case in which there are three levels of drying intensity of the respective divided regions R, namely 30%, 60%, and 100%.

Namely, based on the derived ink droplet application amounts, the derivation section 104 derives the drying intensity for the respective divided regions R employing threshold values expressing boundaries between the respective drying intensity levels, with the maximum amount of ink droplets jetted in the divided regions R being an amount corresponding to the drying intensity of 100%. The control section 106 according to the present exemplary embodiment then controls the drying intensity of the drying units 74 according to the drying intensity derived by the derivation section 104 for each of the divided regions R.

The drying intensity of the drying units 74 refers to the amount of heat applied to the paper P by irradiating infrared rays from the infrared lamps 90 of the drying units 74. In the present exemplary embodiment, as an example, drying intensity is at 100% when a heat amount of 40 kW is applied to ink droplets at 10 g/m². Note that the heat amount corresponding to drying intensity at 100% may be set according to the type of paper P and the type of ink droplets.

Specifically, the control section 106 controls such that total values of the drying intensity by the respective drying units 74 along the conveyance direction match the drying intensity for each of the divided regions R derived by the derivation section 104. Explanation follows regarding the control of the control section 106. Note that in order to avoid confusion, in the present exemplary embodiment, explanation is given in which the total value of the drying intensity of the drying units 74 for each of the divided regions R reaches 100% for the paper P that has passed the position on the conveyance path corresponding to the ink droplet drying section 22 in a state in which all of the infrared lamps 90 are turned on, and in a state in which all of the shutters 92 are open. Namely, in this state, the drying intensity of the drying units 74 for each of the divided regions R is incremented by 10% each time the paper P passes the position of one of the drying units 74 on the conveyance path.

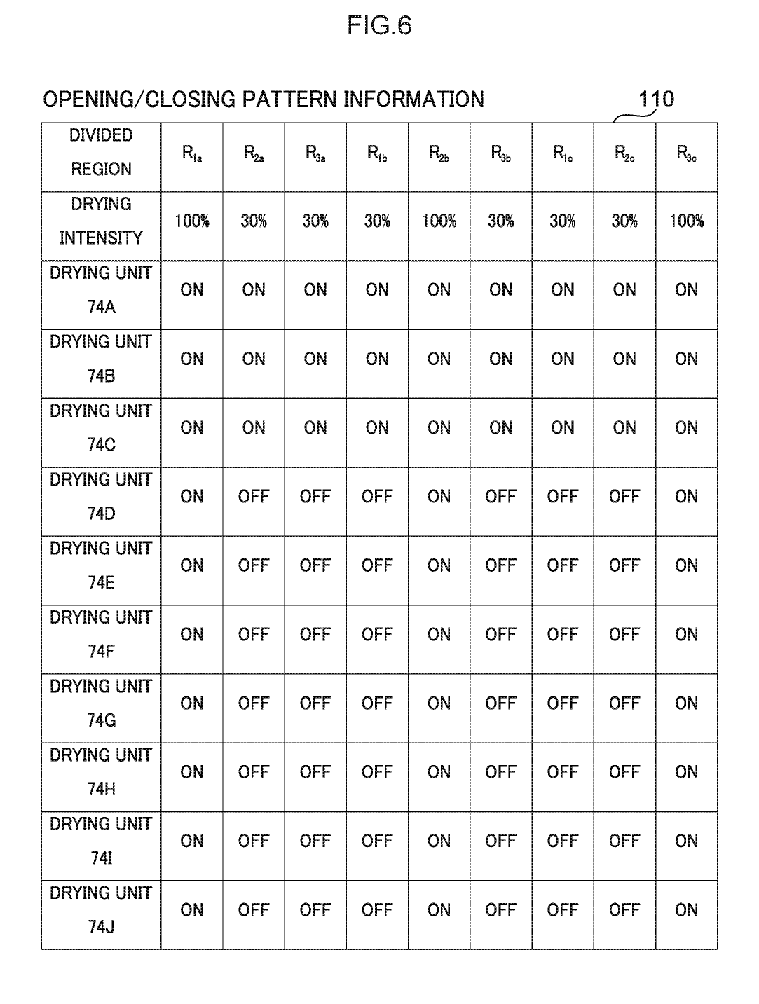

The control section 106 derives opening/closing pattern information 110 indicating a pattern of open/closed states of the respective shutters 92 based on the drying intensity derived by the derivation section 104 for each of the divided regions R, and stores the derived opening/closing pattern information 110 in the storage section 108. FIG. 6 illustrates an example of the opening/closing pattern information 110. Note that as an example, FIG. 6 illustrates the opening/closing pattern information 110 in which the drying intensity for the divided regions R₁ₐ, R_{2b}, R_{3c} is 100%, and the drying intensity for the other divided regions R is 30%.

As illustrated in FIG. 6, the opening/closing pattern information 110 according to the present exemplary embodiment includes information indicating the open/closed states of the shutters 92, corresponding to each of the drying units 74 and each of the divided regions R. In FIG. 6, “ON” indicates the open state of the corresponding shutter 92, and “OFF” indicates the closed state of the corresponding shutter 92.

In the opening/closing pattern information 110 illustrated in FIG. 6, for example, the respective shutters 92A of the drying unit 74A are indicated to be in the open state in a case in which each of the divided regions R passes the corresponding position on the conveyance path. By contrast, for example, the shutter 92D1 of the drying unit 74D is indicated to be in the open state when the divided region R₁ₐ passes the corresponding position on the conveyance path, and be in the closed state in a case in which the divided regions R₂ₐ, R₃ₐ pass the corresponding position on the conveyance path.

The shutter 92D2 of the drying unit 74D is indicated to be in the closed state in a case in which the divided regions R_{1b}, R_{3b} pass the corresponding position on the conveyance path, and is indicated to be in the open state in a case in which the divided region R_{2b} passes the corresponding position on the conveyance path. Moreover, the shutter 92D3 of the drying unit 74D is indicated to be in the closed state in a case in which the divided regions R_{1c}, R_{2c} pass the corresponding position on the conveyance path, and is indicated to be in the open state in a case in which the divided region R_{3c} passes the corresponding position on the conveyance path.

Based on the opening/closing pattern information 110, the control section 106 controls opening and closing of the respective shutters 92 according to a conveyance timing of the paper P being conveyed by the conveyance section 20.

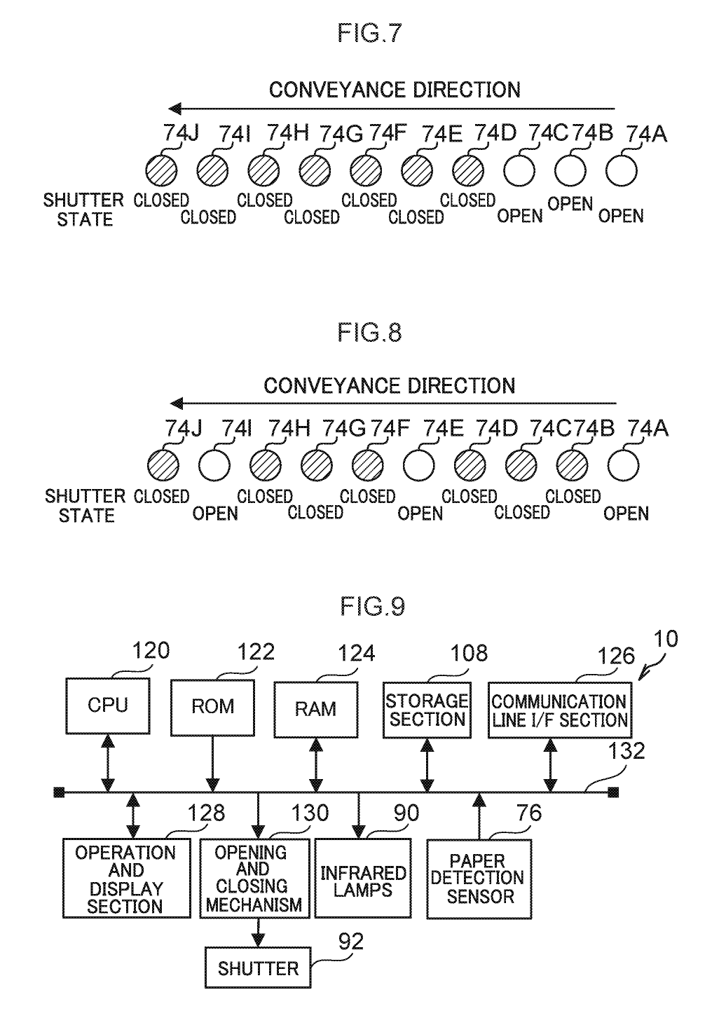

In this manner, as illustrated as an example in FIG. 7, in the present exemplary embodiment, when the drying intensity is less than 100%, a number, corresponding to the drying intensity, of the shutters 92 of consecutive drying units 74 from the drying unit 74 furthest upstream on the conveyance path are placed in the open state. However, there is no limitation thereto. For example, as illustrated in FIG. 8, when the drying intensity is less than 100%, shutters 92 in the closed state may be interposed between shutters 92 in the open state such that the shutters 92 of adjacent drying units 74 are not placed in the open state.

As examples, FIG. 7 and FIG. 8 illustrate open/closed states of the shutters 92A1 to 92J1 as the divided region R_{1b} passes the drying positions of the respective drying units 74 when the divided region R_{1b} has a drying intensity of 30%. In the following explanation, the method for determining the open/closed states of the shutters 92 illustrated in FIG. 7 is referred to as a “front loading method”, and the method for determining the open/closed states of the shutters 92 illustrated in FIG. 8 is referred to as a “thinning method”.

Note that the front loading method enables the ink droplets to be dried at an earlier stage than the thinning method. The front loading method moreover enables the number of times that the shutters 92 are switched between open and closed to be reduced compared to the thinning method.

Note that control to switch the shutters 92 between open and closed when the drying intensity is 60% can be performed similarly when the drying intensity is 30% or 100%.

In the drying units 74, the means for controlling the drying intensity by the control section 106 switching the shutters 92 between open and closed while all of the infrared lamps 90 remain constantly in a turned on state has a fast switching response. This thereby enables the drying intensity applied to the divided regions R to be controlled with a more efficient and simpler configuration, while suppressing a reduction in the conveyance speed of the recording medium.

Next, explanation follows regarding relevant configuration of an electrical system of the inkjet recording device 10 according to the present exemplary embodiment, with reference to FIG. 9.

As illustrated in FIG. 9, the inkjet recording device 10 according to the present exemplary embodiment includes a Central Processing Unit (CPU) 120 that governs overall operation of the inkjet recording device 10, and Read Only Memory (ROM) 122 that is stored in advance with various programs and parameters. The inkjet recording device 10 further includes Random Access Memory (RAM) 124 employed as a work area or the like during execution of the various programs by the CPU 120, and the non-volatile storage section 108 configured by flash memory or the like.

The inkjet recording device 10 further includes a communication line interface (UF) section 126 that exchanges communication data with an external device. The inkjet recording device 10 further includes an operation and display section 128 that receives commands for the inkjet recording device 10 from a user, and displays various information relating to operation status of the inkjet recording device 10 and the like for the user. The operation and display section 128 includes hardware such as a ten-key, a start button, and a display provided with a touch panel that, through execution of a program, displays display buttons to receive operation commands, and display screens displaying various information.

The inkjet recording device 10 further includes the opening and closing mechanism 130 that is connected to the respective shutters 92, and opens and closes the respective shutters 92 individually. The CPU 120, the ROM 122, the RAM 124, the storage section 108, the communication line OF section 126, the operation and display section 128, the opening and closing mechanism 130, the infrared lamps 90, and the paper detection sensor 76 are each connected together through a bus 132.

Due to the above configuration, in the inkjet recording device 10 according to the present exemplary embodiment, the ROM 122, the RAM 124, and the storage section 108, are accessed by the CPU 120, and communication data is exchanged with external devices through the communication line I/F section 126 by the CPU 120. Moreover, in the inkjet recording device 10, various command information is acquired through the operation and display section 128, and various information is displayed on the operation and display section 128, by the CPU 120. Moreover, in the inkjet recording device 10, control to open and close the shutters 92 using the opening and closing mechanism 130, and control to switch the infrared lamps 90 ON and OFF, are respectively performed by the CPU 120.

In the inkjet recording device 10, detection signals output from the paper detection sensor 76 are acquired by the CPU 120. Accordingly, in the inkjet recording device 10, whether or not the paper P is passing the detection position of the paper detection sensor 76 is detected by the CPU 120 based on the signal levels of the acquired detection signals.

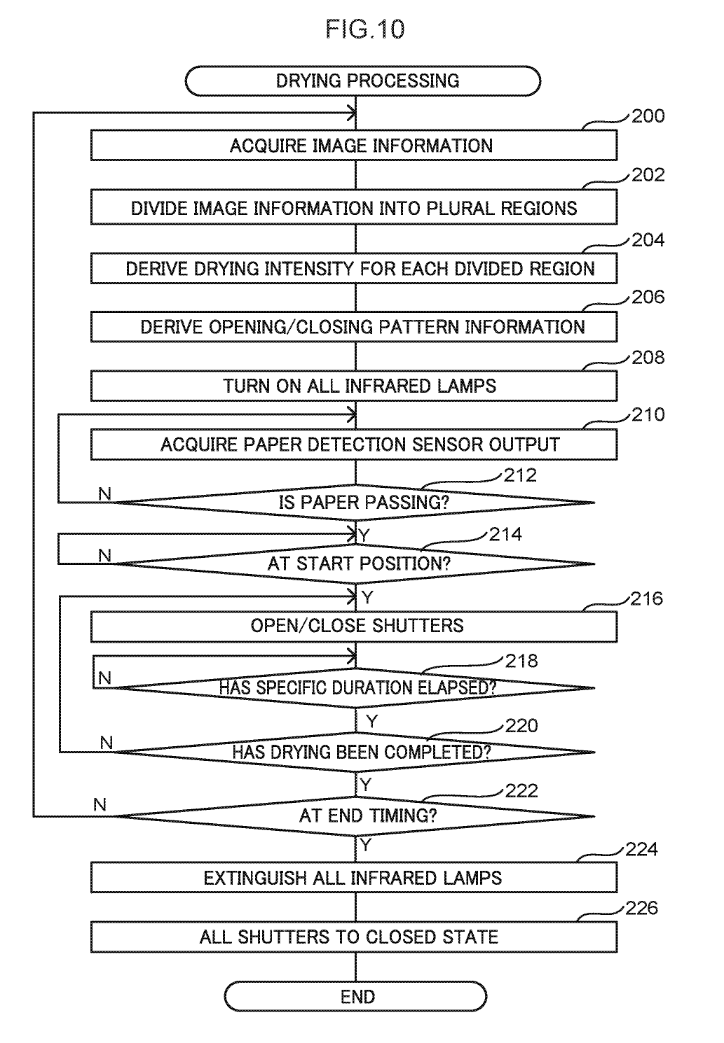

Next, explanation follows regarding operation of the inkjet recording device 10 according to the present exemplary embodiment, with reference to FIG. 10. FIG. 10 is a flowchart illustrating a processing flow of a drying processing program executed by the CPU 120 in a case in which an execution command has been input for a print job (a unit of a processing routine that is executed by a single command for image forming on one or plural sheets of the paper P). The drying processing program is pre-installed in the ROM 122. Note that in order to avoid confusion, explanation relating to processing to form the image on the paper P as described above, and processing to convey the paper P using the conveyance section 20, is omitted.

The explanation given here assumes that the paper P onto which ink droplets have been jetted is being conveyed from upstream of the paper detection sensor 76 in the conveyance direction. In order to avoid confusion, in the explanation given here, in an initial state all of the infrared lamps 90 are extinguished, and all of the shutters 92 are in a closed state. The CPU 120 functions as the acquisition section 100, the division section 102, the derivation section 104, and the control section 106 described above due to the CPU 120 executing the drying processing program.

At step 200 in FIG. 10, the acquisition section 100 acquires the image information expressing the image to be formed by the image forming section 18. At the next step 202, the division section 102 divides the paper P into the plural divided regions R as described above. At the next step 204, the derivation section 104 derives the application amounts of the ink droplets for each of the divided regions R divided at step 202 as described above, based on the image information acquired at step 200. The derivation section 104 then derives the drying intensity according to the application amount derived for each of the divided regions R as described above.

At the next step 206, the control section 106 derives the opening/closing pattern information 110 based on the drying intensity for each of the divided regions R derived at step 204, and stores the derived opening/closing pattern information 110 in the storage section 108. At the next step 208, the control section 106 turns on all of the infrared lamps 90.

At the next step 210, the acquisition section 100 acquires a detection signal output from the paper detection sensor 76. At the next step 212, the acquisition section 100 determines whether or not the leading edge portion of the paper P in the conveyance direction has passed the detection position of the paper detection sensor 76 based on the signal level of the detection signal acquired at step 210. The acquisition section 100 returns to step 210 if determination is negative, and the acquisition section 100 transitions to step 214 if determination is affirmative. Note that in the following explanation, the leading edge portion of the paper P in the conveyance direction is referred to simply as the leading edge portion of the paper P.

At the next step 214, the acquisition section 100 enters standby until the leading edge portion of the paper P reaches a start position where drying by the ink droplet drying section 22 starts. At step 214, a standby duration K1 is found using the following Equation (1), employing a distance D between the detection position of the paper detection sensor 76 and the start position on the conveyance path, and the conveyance velocity V of the paper P.

$$K 1 = \frac{D}{V} \qquad ( 1 )$$

At step 216, based on the opening/closing pattern information 110, the control section 106 controls opening and closing of the respective shutters 92 according to a conveyance timing of the paper P. At step 216, the control section 106 maintains the respective shutters 92 in the same state as on the previous occasion in cases in which the open/closed state following the current control indicated by the opening/closing pattern information 110 is the same state as the open/closed state following the previous control.

At the next step 218, the control section 106 enters standby until a specific duration K2 has elapsed. The standby duration K2 is, for example, found using the following Equation (2), employing a conveyance direction length L of each divided region R of the paper P (see FIG. 5) and the conveyance velocity V.

$$K 2 = \frac{L}{V} \qquad ( 2 )$$

At step 220, the control section 106 determines whether or not a timing predetermined as a drying end timing has been reached. Specifically, the control section 106 determines that the drying end timing has been reached, for example, when the elapsed time from the point at which affirmative determination was made at step 214 has exceeded a predetermined duration that is assumed to be a duration until a rear end portion in the conveyance direction of the paper P passes a drying position of the drying unit 74J. The control section 106 returns to step 216 if determination is negative, and the control section 106 transitions to step 222 if determination is affirmative.

At step 222, the control section 106 determines whether or not the processing of step 200 to step 220 described above has been completed for the number of sheets of the paper P corresponding to the print job. The control section 106 returns to step 200 if determination is negative, and the control section 106 transitions to step 224 if determination is affirmative.

At step 224, the control section 106 extinguishes all of the infrared lamps 90. At the next step 226, the control section 106 places all of the shutters 92 in the closed state so as to end the current drying processing.

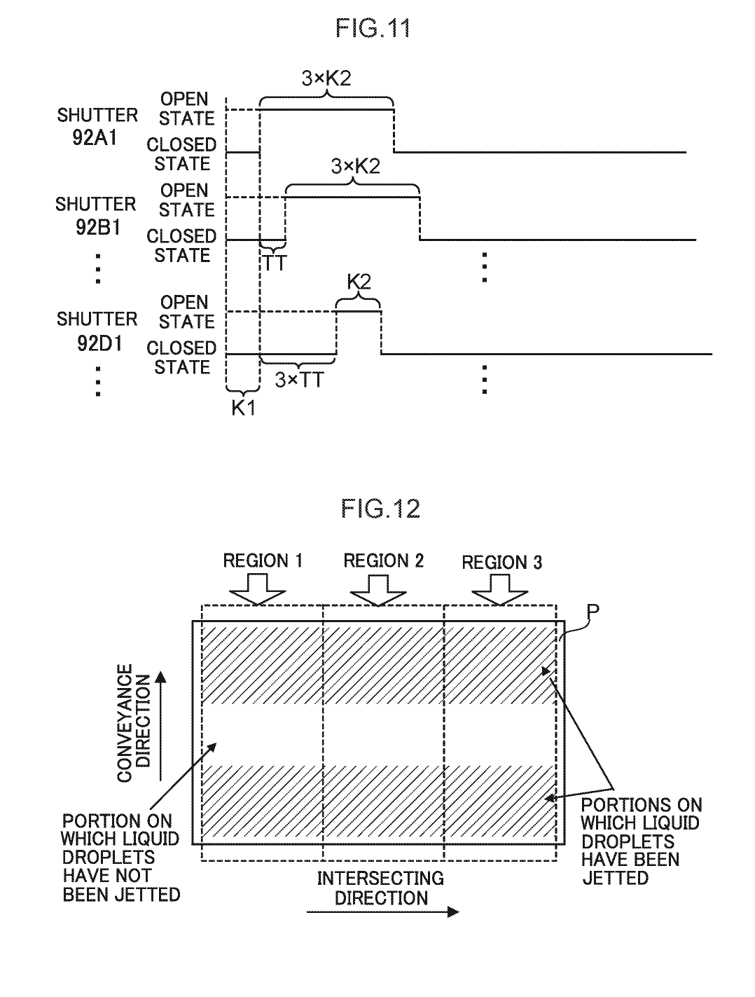

FIG. 11 is a timing chart illustrating the open/closed states of the shutters 92 in the drying processing described above. In order to avoid confusion, FIG. 11 only illustrates the open/closed states of the shutters 92A1, 92B 1, and 92D 1. The left end of the timing chart of FIG. 11 corresponds to a timing at which the leading edge portion of the paper P is detected to have passed the detection position of the paper detection sensor 76 at step 212 of the drying processing.

FIG. 11 moreover illustrates an example in which the open/closed states of the shutters 92 are controlled according to the opening/closing pattern information 110 illustrated in FIG. 6. The duration TT illustrated in FIG. 11 is found using the following Equation (3) employing a distance H between locations corresponding to adjacent drying units 74 on the conveyance path (see FIG. 3), and the conveyance velocity V.

$$TT = \frac{H}{V} \qquad ( 3 )$$

As illustrated in FIG. 11, in the opening/closing pattern information 110 illustrated in FIG. 6, the shutters 92A1, 92B1 are placed in the open state the entire time the paper P is passing the corresponding drying positions. However, in the opening/closing pattern information 110 illustrated in FIG. 6, the shutter 92D1 is placed in the open state while the divided region R₁ₐ is passing the corresponding drying position, and is placed in the closed state while the divided regions R₂ₐ and R₃ₐ are passing the corresponding drying position.

In the exemplary embodiment described above, explanation has been given regarding a case in which the present disclosure is applied to a configuration in which ink droplets that have been jetted onto the paper P are dried. However, there is no limitation thereto. For example, the present disclosure may be applied to a configuration in which process liquid jetted onto the paper P, or a varnish jetted when coating the paper P, is dried.

In the exemplary embodiment described above, explanation has been given regarding a case in which shutters that are mechanically switched between open and closed are employed to switch between blocking and not blocking irradiation of the infrared rays from the infrared lamps. However, there is no limitation thereto. For example, configuration may be made in which electronic shutters such as liquid crystal shutters or the like are employed to switch between blocking and not blocking the infrared rays.

In the exemplary embodiment described above, explanation has been given regarding a case employing a single pass method inkjet recording device. However, there is no limitation thereto. Configuration may be made employing a shuttle scan method inkjet recording device in which the inkjet heads move back and forth in the intersecting direction to form an image.

In the exemplary embodiment described above, explanation has been given regarding a case in which the ink droplets are dried by irradiating infrared rays from the infrared lamps. However, there is no limitation thereto. For example, configuration may be made in which ink droplets are dried by illuminating light from halogen lamps, blowing air with an air blower, or irradiating with a laser using a surface-emitting laser device.

In the exemplary embodiment described above, explanation has been given regarding a case in which opening and closing of the shutters is controlled starting at the timing at which the passage of the paper P is detected by the paper detection sensor. However, there is no limitation thereto. For example, configuration may be made in which opening and closing of the shutters is controlled starting at a timing at which feeding of the paper P from the paper feed section begins. If configured as in this example, it is no longer necessary to provide the inkjet recording device with the paper detection sensor.

In the exemplary embodiment described above, explanation has been given regarding a case in which there are three drying intensity stages, namely the stages of 30%, 60%, and 100%. However, there is no limitation thereto. The number of drying intensity stages may be set to a plural number of stages other than three stages, according to the demanded drying precision or the like. In the exemplary embodiment described above, explanation has been given regarding a case in which ten of the drying units are arranged along the conveyance direction. However, there is no limitation thereto. The plural drying units may be provided along the conveyance direction according to the size of the apparatus, the demanded drying precision, or the like. In such cases, the opening and closing timings of the shutters may be controlled such that infrared rays corresponding to the heat amount needed to dry each of the divided regions, as derived based on the heat amount that would be needed to dry the divided region at 100% drying intensity, and the number of drying intensity stages, are irradiated from the respective infrared lamps according to the drying intensity of the respective divided regions.

In the exemplary embodiment described above, explanation has been given regarding a case in which two types of states, the closed state (fully closed state) and the open state (fully open state), are applied as the open/closed states of the shutters 92. However, there is no limitation thereto. For example, configuration may be made in which states between the fully closed state and the fully open state are also applied as open/closed states of the shutters 92. In such cases, for example, for a divided region R with a drying intensity of 60%, the degree of opening of each corresponding shutter 92 is adjusted such that the paper P is irradiated with a heat amount that is 60% of the heat amount of the fully open state.

Although not mentioned in the exemplary embodiment described above, configuration may be made in which the ink droplet drying section 22 is provided with a temperature detection mechanism such as a thermistor, and an air blowing mechanism such as a fan, as in JP-A No. 2014-176980 from the present applicant, for example.

In the exemplary embodiment described above, explanation has been given in which the drying processing program is stored (installed) in advance in the ROM 122. However, there is no limitation thereto. The drying processing program may be provided recorded on a recording medium such as a Compact Disk Read Only Memory (CD-ROM), a Digital Versatile Disk Read Only Memory (DVD-ROM), or Universal Serial Bus (USB) memory. Moreover, the drying processing program may be downloaded from an external device through a network.

What is claimed is:

1. A drying device comprising:
a drying portion having a plurality of drying units, the drying units configured to dry liquid droplets that have been jetted onto a recording medium with a drying intensity that varies along an intersecting direction intersecting a conveyance direction of the recording medium, with the plurality of drying units being provided along the conveyance direction; and
a control portion that controls the drying intensity of the respective drying units according to an application amount of the liquid droplets in each of a plurality of divided regions, the divided regions defined by dividing the recording medium into regions along the respective directions of the conveyance direction and the intersecting direction.

2. The drying device of claim 1, wherein the control portion controls such that a total value of drying intensity of the respective drying units matches a drying intensity determined according to the application amount of the liquid droplets in each of the divided regions.

3. The drying device of claim 1, wherein the drying units include an infrared lamp as a drying source of the liquid droplets.

4. The drying device of claim 3, wherein the drying units further include a switching member that switches between blocking and not blocking light irradiation from the infrared lamp onto each of the divided regions.

5. The drying device of claim 4, wherein the switching member is a shutter member configured to be opened and closed.

6. The drying device of claim 5, wherein the control portion controls drying intensity of the drying units by controlling opening and closing of the shutter member.

7. The drying device of claim 5, wherein the shutter member is a mechanical shutter member.

8. The drying device of claim 1, wherein the drying unit is configured to vary drying intensity in the intersecting direction so as to correspond to the respective divided regions along the intersecting direction.

9. An inkjet recording device comprising:
a conveyance portion that conveys a recording medium;
a jetting portion that jets ink droplets onto the recording medium being conveyed by the conveyance portion; and
the drying device of claim 1 that dries the liquid droplets, the liquid droplets being the ink droplets on the recording medium being conveyed by the conveyance portion.

10. The inkjet recording device of claim 9, wherein the jetting portion jets the ink droplets using a single pass method.

11. A drying method comprising:
conveying a recording medium onto which liquid droplets have been jetted; and
drying the liquid droplets on the recording medium that is being conveyed by controlling a drying intensity of respective drying units of a drying portion having a plurality of the drying units provided along the conveyance direction, the drying units configured to dry the liquid droplets that have been jetted onto the recording medium with a drying intensity that varies along an intersecting direction intersecting the conveyance direction of the recording medium, according to an application amount of the liquid droplets in each of a plurality of divided regions, the divided regions defined by dividing the recording medium into regions along the respective directions of the conveyance direction and the intersecting direction.
